(19) United States
(12) Patent Application Publication
(10) Pub. No.: US 2008/0014360 A1
(43) Pub. Date: Jan. 17, 2008

(54) Composition for ink acceptable layer of recording medium for image forming apparatus, a recording medium and method for preparing recording medium

(75) Inventor: Kil Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/705,056

(22) Filed: Feb. 12, 2007

(30) Foreign Application Priority Data
Jul. 13, 2006 (KR) 10-2006-0065656

(51) Int. Cl. B41M 5/50

(52) U.S. Cl. 427/384; 428/32.23

(57) ABSTRACT

A composition for an ink acceptable layer has excellent light resistance and discoloration resistance while maintaining improved ink fixation properties and glossiness. A recording medium for an image forming apparatuses using the composition, and a method for preparing the recording medium are also provided. The composition for forming an ink acceptable layer according to an exemplary embodiment includes a fixing agent, an inorganic filler, a binder and a solvent. The fixing agent is a polymeric material containing UV-absorbing constituents.

### CROSS-REFERENCE TO RELATED APPLICATIONS

This application claims the benefit under 35 U.S.C. § 119 (a) of Korean Patent Application No. 10-2006-0065656, filed on Jul. 13, 2006, in the Korean Intellectual Property Office, the entire disclosure of which is hereby incorporated by reference in its entirety.

### BACKGROUND OF THE INVENTION

1. Field of the Invention

The present invention relates to a composition for an ink acceptable layer, a recording medium for image forming apparatuses using the composition, and a method for preparing the recording medium. More particularly, the present invention relates to a composition for an ink acceptable layer having excellent light resistance and discoloration resistance while maintaining improved ink fixation properties and glossiness. The invention is further directed to a recording medium for image forming apparatuses using the composition, and a method for preparing the recording medium.

2. Description of the Related Art

The printing methods of image forming apparatuses are largely divided into two types: non-impact printing and impact printing. The printing method used in the inkjet printers is a non-impact printing method, and has advantages that include a low noise level, compared to impact printing methods, and an ability to display colors more readily than laser beam printers. Also, inkjet printers and printing methods are inexpensive, have a high output speed and produce high-resolution images. Consequently, this printing method is widely used.

Printing paper usable in inkjet printers includes various recording media such as specially coated inkjet paper and inkjet film, as well as plain paper. If a recording medium for the inkjet image forming apparatus has a hydrophobic substrate comprising polyester, such as cellulose acetate or polyethylene terephthalate, the hydrophobic substrate is coated with a hydrophilic material so that ink can be readily fixed on the recording medium. In this case, the coating layer comprising the hydrophilic material is called an “ink acceptable layer”.

The recording media for inkjet image forming apparatuses comprising a hydrophobic substrate and an ink acceptable layer are applied to printing digital photographs or images using thermal type, piezo type or phase-change type inkjet image forming apparatuses, and can be used in numerous applications, such as presentation utilities on an Over Head Projector, and for outer wall decor, designs or advertising.

In general, recording media need to preserve a recorded state for a long period of time without becoming deformed or worn. Thus, there is a demand for the development of a recording medium for inkjet image forming apparatuses capable of preserving a printed state for a long period of time.

U.S. Pat. No. 5,866,268, JP 55-144,172, and JP 62-268,682, disclose recording media with an ink absorption rate and ink absorption amount values improved by using a hydrophilic resin binder, such as cellulose derivatives, polyvinyl alcohols, or the like. However, the recording media disclosed in the above patents have low water resistance since the hydrophilic resin is easily dissolved in water, causing blurring of the image printed on the recording media.

JP 59-198,186, and JP 56-84,992 disclose recording media having an ink acceptable layer comprising an organic acid salt of polyethylene amine. In these patents, the water resistance of the recording media is improved, but the thermal resistance and light resistance are reduced, so that yellowing by ultraviolet light (UV) may occur.

Also, the use of an alumina as an inorganic filler contained in an ink acceptable layer of the recording media has increasingly attracted attention. The alumina has advantages in that it has a greater ability to fix a dye in the ink than in other inorganic fillers, and can form a high gloss image.

Recording media are also disclosed in U.S. Pat. Nos. 4,879,166 and 5,104,730, JP 2-276,670, JP 4-37,576 and JP 5-32,037, where the recording media comprise an alumina hydrate having a boehmite structure. In addition, JP 60-67,190, JP 61-10,584 and JP 61-57,379, disclose inkjet recording sheets having a cationic polymer and a water-soluble polyvalent metal salt. The recording media disclosed in the above patents show highly improved dye fixation and short-term water resistance, but their light resistance is still unsatisfactory. Particularly, some of the above patents have substantially decreased high temperature moisture resistance.

Additionally, to prepare inkjet recording sheets which exhibit a good chromogenic performance and also have good keeping properties (particularly light resistance), a method for adding at least one kind of a cationic fixing agent, a water-soluble metal salt, and a UV absorber to a coating layer (referring to JP 2000-318,307, JP 2000-37,951, JP 2000-108,500, JP 2000-141,874, JP 11-254,811, JP 2000-309,160, JP 2000-309,161, JP 2003-72,233, JP 8-174,990, JP 9-254,529, or the like) is increasingly suggested. However, in the above patents, when a UV absorber is added, compatibility with other hydrophilic materials and film strength may be reduced, because the UV absorber is generally a hydrophobic compound.

### SUMMARY OF THE INVENTION

Exemplary embodiments of the present invention address at least the above problems and/or disadvantages and provide at least the advantages described below. Accordingly, an exemplary aspect of the present invention is to provide a composition for an ink acceptable layer having excellent light resistance and discoloration resistance while maintaining improved ink fixation properties and glossiness, a recording medium for image forming apparatuses using the composition, and a method for preparing the recording medium.

The foregoing and other objects and advantages are substantially realized by providing a composition for forming an ink acceptable layer of a recording medium for image forming apparatuses, comprising a fixing agent, an inorganic filler, a binder, and a solvent, wherein the fixing agent is a polymer material including ultraviolet light (UV)-absorbing constituents. The fixing agent is preferably an acrylate based cationic latex.

In an exemplary implementation, the fixing agent is represented by the following Formula (I),

-[A]ₗ-[B]ₘ—[C]ₙ— (I)

in which A is a radical polymerizable monomer containing at least one of a tertiary amino group and a quaternary ammonium group; B is a radical polymerizable monomer copolymerizable with A, C is a UV absorbing monomer and is selected from the group consisting of a benzophenone-based UV-absorbing monomer, a benzotriazole-based UV-absorbing monomer and a formamidine-based UV-absorbing monomer, I is a natural number from 5 to 40, m is a natural number from 40 to 75, n is a natural number from 20 to 55, and l+m+n=100.

In an exemplary implementation, in Formula (I), A is selected from the group consisting of di-C₁-C₄ alkylamino-C₂-C₃ alkyl acrylamides and salts thereof, di-C₁-C₄ alkylamino-C₂-C₃ alkyl methacrylamides and salts thereof, di-C₁-C₄ alkylamino-C₂-C₃ alkyl acrylates and salts thereof, di-C₁-C₄ alkylamino-C₂-C₃ alkyl methacrylates and salts thereof, di-C₁-C₄ alkylamino-C₂-C₃ alkyl-substituted aromatic vinyl compounds and salts thereof, and nitrogen containing heterocyclic radical polymerizable monomers and salts thereof.

In an exemplary implementation, in Formula (I), B is selected from the group consisting of an unsaturated aromatic compound, an α,β-unsaturated monocarboxylic acid alkyl ester, an amide group-containing compound, an unsaturated carboxylic acid, and a hydroxyl group-containing compound.

In an exemplary implementation, the unsaturated aromatic compound is a compound selected from the group consisting of styrene, α-methyl styrene, and vinyl toluene. The alkyl ester of the α,β-unsaturated monocarboxylic acid is either an alkyl ester of acrylic acid or an alkyl ester of methacrylic acid. The alkyl ester of acrylic acid is selected from the group consisting of methyl acrylate, ethyl acrylate, propyl acrylate, isopropyl acrylate, butyl acrylate, isobutyl acrylate, hexyl acrylate, cyclohexyl acrylate, 2-ethylhexyl acrylate, and lauryl acrylate. The alkyl ester of methacrylic acid is selected from the group consisting of methyl methacrylate, ethyl methacrylate, propyl methacrylate, isopropyl methacrylate, butyl methacrylate, isobutyl methacrylate, hexyl methacrylate, cyclohexyl methacrylate, 2-ethylhexyl methacrylate, and lauryl methacrylate. The amide group-containing compound is selected from the group consisting of acrylamide, methacrylamide, N,N-methylene bisacrylamide, diacetone acrylamide, maleic acid amide, and maleimide.

In an exemplary implementation, the unsaturated carboxylic acid is selected from the group consisting of acrylic acid, methacrylic acid, maleic acid, fumaric acid, itaconic acid, and monoalkyl itaconate.

In an exemplary implementation, the hydroxyl group-containing compound is selected from the group consisting of 2-hydroxyethyl acrylate, 2-hydroxyethyl methacrylate, hydroxypropyl acrylate, hydroxypropyl methacrylate, and polyethylene glycol acrylate.

In an exemplary implementation, the benzophenone-based UV-absorbing monomer is represented by the following Formula (II),

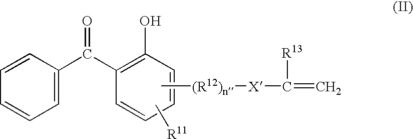

in which R¹¹ is selected from the group consisting of a hydrogen atom, a C₁-C₆ alkyl group, and a C₁-C₆ alkoxy group; R¹² is selected from the group consisting of a C₁-C₁₀ alkylene group, and a C₁-C₁₀ oxyalkylene group; R¹³ is selected from the group consisting of a hydrogen atom, and a C₁-C₄ alkyl group; X¹ is an ester bond, an amide bond, an ether bond, or a urethane bond; and n¹¹ is 0 or 1.

In an exemplary implementation, the benzotriazole-based UV-absorbing monomer is represented by the following Formula (III),

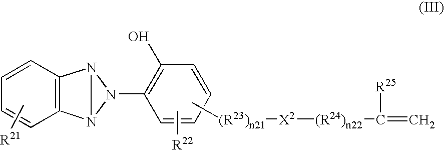

in which R²¹ is selected from the group consisting of a hydrogen atom, a halogen atom, and a methyl group; R²² is selected from the group consisting of a hydrogen atom, and a C₁-C₆ hydrocarbon group; R²³ is selected from the group consisting of a C₁-C₁₀ alkylene group, and a C₁-C₁₀ oxyalkylene group; R²⁴ is selected from the group consisting of a C₁-C₈ alkylene group, a C₁-C₈ alkylene group with an amino group, and a C₁-C₈ alkylene group with a hydroxyl group; R²⁵ is selected from the group consisting of a hydrogen atom, and a C₁-C₄ alkyl group; X² is one of an ester bond, an amide bond, an ether bond, and a urethane bond; and n²¹ and n²² are 0 or 1.

In an exemplary implementation, the formamidine-based UV-absorbing monomer is represented by the following Formula (IV),

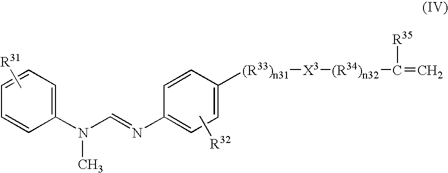

in which R³¹ is selected from the group consisting of a hydrogen atom, a halogen atom, and a methyl group; R³² is selected from the group consisting of a hydrogen atom, and a C₁-C₆ hydrocarbon group; R³³ is selected from the group consisting of a C₁-C₁₀ alkylene group, and a C₁-C₁₀ oxyalkylene group; R³⁴ is selected from the group consisting of a C₁-C₈ alkylene group, a C₁-C₈ alkylene group with an amino group, and a C₁-C₈ alkylene group with a hydroxyl group; R³⁵ is selected from the group consisting of a hydrogen atom, and a C₁-C₄ alkyl group; X² is one of an ester bond, an amide bond, an ether bond, and a urethane bond; and n³¹ and n³² are 0 or 1.

In an exemplary implementation, the fixing agent has a particle size of 10 nm to 500 nm, and the content of the fixing agent is 0.5 to 25 parts by weight, based on 100 parts by weight of the total solid content of the composition of the ink acceptable layer.

In an exemplary implementation, the inorganic filler is selected from the group consisting of alumina, calcium carbonate, kaolin, talc, calcium sulfate, barium sulfate, titanium oxide, zinc oxide, zinc carbonate, aluminum silicate, silicic acid, sodium silicate, magnesium silicate, calcium silicate and silica.

In an exemplary implementation, particularly when the inorganic filler is alumina, the alumina is represented by the following Formula (V),

Al₂O₃₋ₚ(OH)₂ₚ·_{q}H₂O (V)

in which p is an integer from 0 to 3; and q is a rational number from 0 to 10. Additionally, the alumina may have either a boehmite structure or an amorphous structure.

In an exemplary implementation, the alumina has a particle size of about 20 nm to about 200 nm, and the content of the alumina is about 50 to about 95 parts by weight, based on 100 parts by weight of the total solid content of the composition of the ink acceptable layer.

In an exemplary implementation, the binder comprises a polyvinyl alcohol. The polyvinyl alcohol preferably has a polymerization degree of 1000 or more, and a degree of saponification of 70 to 100 parts. In addition to the polyvinyl alcohol, the binder further comprises one or more compounds selected from the group consisting of polyvinylpyrrolidone, methyl cellulose, hydroxypropylmethyl cellulose, gelatin, starch, polyethylene oxide, acrylic polymers, polyesters and polyurethanes. The content of the compound further contained is 1 to 50 parts by weight, based on 100 parts by weight of the total weight of the polyvinyl alcohol. One or more of these compounds are included in an amount of about 5 to about 30 parts by weight, based on 100 parts by weight of the total solid content of the composition of the ink acceptable layer.

In an exemplary implementation, the solvent comprises water and one or more organic solvents selected from the group consisting of ketones, glycol ethers, alcoholic solvents, methyl cellosolve, ethyl cellosolve, dimethylformamide and dimethylsulfoxide. Among these, the water content is about 5 to about 40 parts by weight, based on 100 parts by weight of the total solid content of the composition of the ink acceptable layer. The content of the organic solvents is about 5 to about 50 parts by weight, based on 100 parts by weight of the total weight of the solvent.

In an exemplary implementation, the composition for forming an ink acceptable layer further comprises a cross-linker. The cross-linker is selected from the group consisting of oxazoline, isocyanate, epoxide, aziridine, melamine formaldehyde, dialdehyde, boron compounds, zirconium compounds and mixtures thereof.

The foregoing and other objects and advantages are substantially realized by providing a recording medium for an image forming apparatus comprising a substrate wherein an ink acceptable layer is formed from a composition for forming an ink acceptable layer comprising a fixing agent including polymeric materials containing UV-absorbing constituents, an inorganic filler, a binder, and a solvent. The ink acceptable layer has a thickness of about 8 μm to about 80 μm.

In an exemplary implementation, the substrate is selected from the group consisting of transparent or translucent polyester films, polycarbonate films, cellulose-acetate films, polyethylene films, paper with at least one side coated with polyethylene or polypropylene, single-sided art paper or double-sided art paper, cast coated paper, synthetic paper and photographic paper. The substrate has a thickness of 70 μm to 350 μm.

In an exemplary implementation, the recording medium further comprises one or more layers selected from an undercoating layer disposed between the substrate and the ink acceptable layer, a protective layer disposed on an upper surface of the ink acceptable layer, and a back coating layer disposed on an opposite lower surface of the substrate.

In an exemplary implementation, the undercoating layer comprises one material selected from the group consisting of bi-component primer of a polyol and a polyisocyanate or a mono-component primer of acryl, urethane, acryl-urethane and vinyl based compounds. The protective layer comprises either a compound comprising a cellulose and a cross-linker, or a compound comprising a polyethylene oxide and a cross-linker. The back coating layer comprises one compound selected from polyvinyl alcohol, polyvinylpyrrolidone, methyl cellulose, hydroxypropylmethyl cellulose, gelatin, polyethylene oxide, acrylic polymer, polyester, polyurethane, oxazoline, isocyanate, epoxide, aziridine, melamine-formaldehyde, dialdehyde and boron compounds.

In an exemplary implementation, the undercoating layer has a thickness of about 0.2 μm to about 2.0 μm, the protective layer has a thickness of about 0.5 μm to about 3 μm, and the back coating layer has a thickness of about 0.5 μm to about 4 μm.

The foregoing and other objects and advantages are substantially realized by providing a method for preparing a recording medium for image forming apparatuses comprising preparing a composition for forming an ink acceptable layer, which comprises a fixing agent including polymeric materials containing UV-absorbing constituents, an inorganic filler, a binder, and a solvent; coating the composition for forming an ink acceptable layer on a substrate; and drying the substrate coated with the composition at a temperature from 50° C. to 130° C.

### BRIEF DESCRIPTION OF THE DRAWINGS

The above aspects and features of embodiments of the present invention will become more apparent by describing certain exemplary embodiments of the present invention with reference to the accompanying drawing, in which:

FIG. 1 is a cross-sectional view illustrating a recording medium for image forming apparatuses according to an exemplary embodiment of the present invention.

### DETAILED DESCRIPTION OF THE INVENTION

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Hereinafter, exemplary embodiments of the present invention will be described in detail with reference to the accompanying drawings.

A composition for forming an ink acceptable layer of a recording medium for image forming apparatuses according to an exemplary embodiment of the present invention, includes a fixing agent, an inorganic filler, a binder, and a solvent.

The fixing agent is preferably a polymeric material, such as an acrylate based cationic latex containing ultraviolet light (UV)-absorbing constituents in the polymeric structure. As the cationic latex containing UV-absorbing constituents, any constituent having a polymeric structure with a cationic group containing UV-absorbing constituents can be used as a UV-absorbing constituent.

The cationic latex used as the fixing agent according to the exemplary embodiment of the present invention comprises a constituent unit which has a cationic group, a constituent unit which acts as a cross-linker during copolymerization, a constituent unit which has no ionic properties, and a constituent unit which has reactive UV-absorbing constituents.

In general, dyes used in color ink for image forming apparatuses are direct dyes or acidic dyes, and are ionically bonded with the cationic latex, since they have a carboxyl group (—COOH) or a sulfonic acid group (—SO₃H), which have anionic properties, in their molecules.

Accordingly, the dyes are fixed on a recording medium by a relatively strong ionic bond, so that the ink is contained in the medium. Therefore, when the cationic latex is used as a fixing agent for the dye, an image formed by the dye has improved water resistance and fixation property.

The cationic latex containing UV-absorbing constituents may be prepared using a UV absorber as a reactive unit to contain a polymeric UV absorber. Accordingly, it is possible to solve the problem of external-additive UV absorbers used when the UV absorber is added to the composition for forming an ink acceptable layer. Hereinbelow, a UV absorber contained in the polymeric structure of the fixing agent used in the composition for forming an ink acceptable layer according to the exemplary embodiment of the present invention is denoted as “internal-additive UV absorber.” In contrast, a UV absorber added to the composition for forming an ink acceptable layer is denoted as “external-additive UV absorber.”

By using the cationic latex containing UV-absorbing constituents, a printed image may have improved light resistance and discoloration resistance. Since the concentration of the UV absorber may be arbitrarily adjusted, characteristics of the reactive UV absorber may be exhibited compared to the external-additive UV absorber.

The fixing agent is represented by the following Formula (I).

-[A]ₗ-[B]ₘ—[C]ₙ— (I)

In Formula (I), A is a radical polymerizable monomer containing at least one of a tertiary amino group and a quaternary ammonium group; B is a radical polymerizable monomer copolymerizable with A; and C is a UV absorbing monomer selected from the group consisting of a benzophenone-based UV-absorbing monomer, a benzotriazole-based UV-absorbing monomer and a formamidine-based UV-absorbing monomer. Additionally, in a molar ratio of each monomer, 1 is a natural number from 5 to 40, m is a natural number from 40 to 75, n is a natural number from 20 to 55, and l+m+n=100.

As a polymeric monomer, A may be any of various radical polymerizable monomers, which contain a quaternary ammonium base or capable of forming the quaternary ammonium base, in addition to a tertiary amino group or radical polymerizable monomer with a base thereof.

In Formula (I), A may be selected from the group consisting of, for example, a di-C₁-C₄ alkylamino-C₂-C₃ alkyl(meth)acrylamide such as a dimethylaminoethyl(meth)acrylamide, a diethylaminoethyl(meth)acrylamide, a dimethylaminopropyl(meth)acrylamide and a diethylaminopropyl(meth)acrylamide and salts thereof, and a salt thereof; a di-C₁-C₄ alkylamino-C₂-C₃ alkyl(meth)acrylate such as a dimethylaminoethyl(meth)acrylate, a diethylaminoethyl(meth)acrylate, a dimethylaminopropyl(meth)acrylate, a diethylaminopropyl(meth)acrylate and salts thereof, and a salt thereof; a di-C₁-C₄ alkylamino-C₂-C₃ alkyl-substituted aromatic vinyl compound such as a 4-(2-dimethylaminoethyl)styrene, a 4-(2-dimethylaminopropyl)styrene and salts thereof, and a salt thereof; and a nitrogen containing heterocyclic radical polymerizable monomer such as a vinyl pyridine, a vinyl imidazole, a vinyl pyrrolidone and salts thereof, and a salt thereof; but are not particularly limited thereto.

In this case, examples of the salts may include hydrohalides such as hydrochloride and hydrobromide; alkyl halides such as methyl chloride, ethyl chloride, propyl chloride, butyl chloride, benzyl chloride, epichlorohydrin, methyl bromide, ethyl bromide, propyl bromide and butyl bromide; and carboxylates such as alkyl sulfonate, aryl sulfonate, formate and acetate; but are not particularly limited thereto.

In Formula (I), B may be selected from an unsaturated aromatic compound, an α,β-unsaturated monocarboxylic acid alkyl ester, an amide group-containing compound, an unsaturated carboxylic acid, and a hydroxyl group-containing compound.

Examples of the unsaturated aromatic compound may include styrene, a-methyl styrene, and vinyl toluene, but are not particularly limited thereto.

Examples of the alkyl ester of the α,β-unsaturated monocarboxylic acid may include an alkyl ester of acrylic acid and an alkyl ester of methacrylic acid.

Examples of the alkyl ester of acrylic acid include methyl acrylate, ethyl acrylate, propyl acrylate, isopropyl acrylate, butyl acrylate, isobutyl acrylate, hexyl acrylate, cyclohexyl acrylate, 2-ethylhexyl acrylate, and lauryl acrylate, but are not particularly limited thereto.

Examples of the alkyl ester of methacrylic acid include methyl methacrylate, ethyl methacrylate, propyl methacrylate, isopropyl methacrylate, butyl methacrylate, isobutyl methacrylate, hexyl methacrylate, cyclohexyl methacrylate, 2-ethylhexyl methacrylate, and lauryl methacrylate, but are not particularly limited thereto.

Examples of the amide group-containing compound include acrylamide, methacrylamide, N,N-methylene bisacrylamide, diacetone acrylamide, maleic acid amide, and maleimide, but are not particularly limited thereto. Examples of the unsaturated carboxylic acid include acrylic acid, methacrylic acid, maleic acid, fumaric acid, itaconic acid, and monoalkyl itaconate, but are not particularly limited thereto.

Additionally, examples of the hydroxyl group-containing compound include 2-hydroxyethyl acrylate, 2-hydroxyethyl methacrylate, hydroxypropyl acrylate, hydroxypropyl methacrylate, and polyethylene glycol acrylate, but are not particularly limited thereto.

In Formula (I), C is a UV-absorbing monomer, which is contained as the UV-absorbing constituent in the polymeric structure of the fixing agent. C may be any monomer capable of absorbing UV radiation. In particular, C may be selected from a benzophenone-based UV-absorbing monomer, a benzotriazole-based UV-absorbing monomer and a formamidine-based UV-absorbing monomer.

Preferably, the benzophenone-based UV-absorbing monomer, which may be used as C, is represented by the following Formula (II).

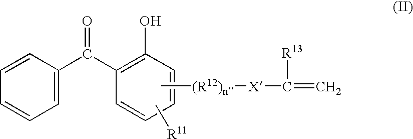

In Formula (II), R¹¹ may be selected from the group consisting of a hydrogen atom, a C₁-C₆ alkyl group, and a C₁-C₆ alkoxyl group; R¹² may be selected from the group consisting of a C₁-C₁₀ alkylene group, and a C₁-C₁₀ oxyalkylene group; and R¹³ may be selected from the group consisting of a hydrogen atom, and a C₁-C₄ alkyl group.

X¹ may be an ester bond, an amide bond, an ether bond, and a urethane bond; and n¹¹ may be 0 or 1.

Preferably, the benzotriazole-based UV-absorbing monomer, which may be used as C, is represented by the following Formula (III).

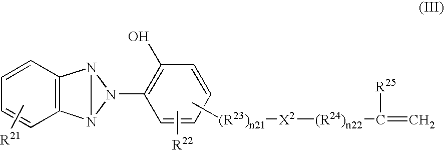

In Formula (III), R²¹ may be selected from the group consisting of a hydrogen atom, a halogen atom, and a methyl group; R²² may be selected from the group consisting of a hydrogen atom, and a C₁-C₆ hydrocarbon group; R²³ may be selected from the group consisting of a C₁-C₁₀ alkylene group, and a C₁-C₁₀ oxyalkylene group; R²⁴ may be selected from the group consisting of a C₁-C₈ alkylene group, a C₁-C₈ alkylene group with an amino group, and a C₁-C₈ alkylene group with a hydroxyl group; and R²⁵ may be selected from the group consisting of a hydrogen atom, and a C₁-C₄ alkyl group.

X² may be one of an ester bond, an amide bond, an ether bond, and a urethane bond; and n²¹ and n²² may be 0 or 1.

Preferably, the formamidine-based UV-absorbing monomer, which may be used as C, is represented by the following Formula (IV).

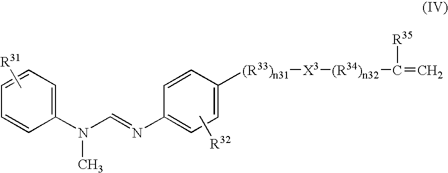

In Formula (IV), R³¹ may be selected from the group consisting of a hydrogen atom, a halogen atom, and a methyl group; R³² may be selected from the group consisting of a hydrogen atom, and a C₁-C₆ hydrocarbon group; R³³ may be selected from the group consisting of a C₁-C₁₀ alkylene group, and a C₁-C₁₀ oxyalkylene group; R³⁴ may be selected from the group consisting of a C₁-C₈ alkylene group, a C₁-C₈ alkylene group with an amino group, and a C₁-C₈ alkylene group with a hydroxyl group; and R³⁵ may be selected from the group consisting of a hydrogen atom, and a C₁-C₄ alkyl group.

X² may be one of an ester bond, an amide bond, an ether bond, and a urethane bond; and n³¹ and n³² may be 0 or 1.

In Formula (I), the internal-additive UV absorber blocks ultraviolet light, which weakens the bonds of the polymers, and the internal additive UV absorber also suppresses the activity of the molecules and absorbs energy to convert it into heat. This effect can be partially achieved by using the external-additive UV absorber. However, since the external-additive UV absorber is generally a hydrophobic compound, the external-additive UV absorber has a low compatibility with aqueous compositions. Accordingly, the content of the external-additive UV absorber is limited, and smoothness and transparency of the coating layer, and film strength may be reduced.

The fixing agent contained in the composition for forming an ink acceptable layer according to the exemplary embodiment of the present invention has a particle size of preferably 10 nm to 500 nm, and more preferably 50 nm to 300 nm. A fixing agent with a particle size of 10 nm or more does not cause any particular problems when the latex is prepared, and the stability of the composition is maintained until the particle size reaches 500 nm.

If, in the composition for forming an ink acceptable layer, the content of the cationic latex as the fixing agent, containing the UV-absorbing constituents is too low, the use objective thereof is not achieved, while if the content is too high, disadvantages arise when printing images using the ink. Accordingly, the content of the fixing agent is preferably about 0.5 to about 25 parts by weight, based on the weight of the solid content of the composition for forming an ink acceptable layer.

The cationic latex as the fixing agent may have a multilayer structure comprising a core part and a shell part.

The inorganic filler contained in the composition for forming an ink acceptable layer according to the exemplary embodiment of the present invention includes, for example, alumina, calcium carbonate, kaolin, talc, calcium sulfate, barium sulfate, titanium oxide, zinc oxide, zinc carbonate, aluminum silicate, silicic acid, sodium silicate, magnesium silicate, calcium silicate and silica, but is not particularly limited thereto.

In particular, the inorganic filler is preferably the alumina, and the alumina may be represented by the following Formula (V).

Al₂O₃₋ₚ(OH)₂ₚ·_{q}H₂O (V)

In Formula (V), p is an integer from 0 to 3; and q is a rational number from 0 to 10 and preferably from 0 to 5.

Typically, water (H₂O) in the form of an alumina hydrate represents an aqueous phase capable of evaporating without participating in the formation of crystal lattices. Therefore, q need not be a whole number.

In addition, the alumina may have a boehmite structure or an amorphous structure.

The reason why the alumina is preferably used as an inorganic filler is based on the following. Since the alumina has a positive charge, it can improve fixation of a dye on the ink acceptable layer and simultaneously produce an image with high print density, excellent color and good transparency. Also, the alumina forms a porous layer and thus, can improve the ink absorption of the ink acceptable layer. A porous layer type using alumina has an ink acceptable layer mainly which comprises a pigment, and thus has excellent water resistance. Also, a porous layer type is advantageous in that it can control surface properties, for example, by eliminating adhesion between films which may occur when a binder is used alone.

The alumina is used as a powder or may be used in the form of a sol (alumina sol) comprising alumina in the form of particles in some cases. When alumina sol is used, if the particles in the sol are too small, the ink absorption is reduced, while if the particles are too big, transparency of the recording medium can deteriorate.

Preferably, the alumina has a particle size of about 20 nm to about 200 nm.

Considering the desirable effect on the composition for forming an ink acceptable layer, the content of the alumina is preferably about 50 to about 95 parts by weight, based on 100 parts by weight of the total solid content of the composition of the ink acceptable layer.

In addition to the alumina, the composition for forming an ink acceptable layer may further include other inorganic fillers, for example inorganic pigments such as calcium carbonate, kaolin, talc, calcium sulfate, barium sulfate, titanium oxide, zinc oxide, zinc carbonate, aluminum silicate, silicic acid, sodium silicate, magnesium silicate, calcium silicate and silica; organic pigments such as plastic pigments and urea resin pigments; or a mixture thereof. The above inorganic fillers may be used together with the alumina. Such inorganic fillers are preferably contained in an amount of 20 parts by weight or less, based on the content of the alumina.

The binder contained in the composition for forming an ink acceptable layer according to the exemplary embodiment of the present invention is preferably a hydrophilic binder, and more preferably a polyvinyl alcohol. A polyvinyl alcohol is often used as a binder since it has high ink suitability and is a good adhesive for inorganic fillers.

The polyvinyl alcohol preferably has a polymerization degree of 1000 or more. A degree of saponification for the polyvinyl alcohol is preferably about 70 to about 100 parts, and more preferably about 80 to about 99.5 parts.

In addition to the polyvinyl alcohol, the binder further includes one or more compounds selected from the group consisting of polyvinylpyrrolidone, methyl cellulose, hydroxypropylmethyl cellulose, gelatin, starch, polyethylene oxide, acrylic polymers, polyesters and polyurethanes. These compounds are preferably included in an amount of about 1 to about 50 parts by weight, and more preferably about 1 to about 20 parts by weight, based on 100 parts by weight of the total weight of the polyvinyl alcohol.

The total content of the binder is preferably about 5 to 30 parts by weight, and more preferably about 5 to 25 parts by weight, based on 100 parts by weight of the total solid content of the composition of the ink acceptable layer.

If the content of the polyvinyl alcohol is too low, the binder cannot perform its function, and thus the adhesion between the ink acceptable layer containing the polyvinyl alcohol as a binder and the substrate is reduced. Also, since proportions of other components such as the pigment are relatively increased, surface properties of the ink acceptable layer is reduced, for example, causing cracks to occur. If the content of the polyvinyl alcohol is too high, the ink acceptable layer is composed of the binder alone, so the ink absorption and instant dry characteristics may be reduced.

The solvent of the composition for forming an ink acceptable layer according to the exemplary embodiment of the present invention is not particularly limited. However, considering environmental problems and practicability, water is usually used.

Also, ketones, glycol ethers, alcoholic solvents, methyl cellosolve, ethyl cellosolve, dimethylformamide or dimethylsulfoxide can be used. Examples of the ketones include acetone or methyl ethyl ketone, and examples of the glycol ethers include diethylene glycol or monobutyl ether, but are not particularly limited thereto. Examples of alcoholic solvents include methanol, ethanol, butanol and isopropanol, but are not particularly limited thereto.

The solvent is preferably included in a range to make the solid content in the composition for forming an ink acceptable layer to be about 5 to about 40% by weight. If the content of the solvent is too high, the viscosity is too low and the drying during coating becomes difficult. If the content of the solvent is too high, the viscosity is too high and the coating surface properties may deteriorate.

The content of the alcoholic and other organic solvents, except for water, are preferably included in an amount of about 5 to about 50 parts by weight, based on the total solvent content. This is because when the content of the alcoholic solvents and other organic solvents is too low, the drying properties are reduced, while when the content is too high, the solubility of the composition can be reduced, causing an increase in the price of the final product.

Preferably, the composition for forming an ink acceptable layer according to the exemplary embodiment of the present invention further includes an additive to complement its properties. In particular, the composition for forming an ink acceptable layer may further contain a cross-linker.

The cross-linker can increase water resistance and surface strength by cross-linking a binder component and an inorganic filler component. If the content of the cross-linker is too low, the cross-linking has no effect, while if the content of the cross-linker is too high, the cross-linking degree is excessive, causing a reduction in the ink absorption. Considering these factors, the cross linker is preferably added in an amount of about 0.015 to about 8 parts by weight, based on 100 parts by weight of the total solid content of the composition of the ink acceptable layer.

Examples of the cross linker include oxazoline, isocyanate, epoxide, aziridine, melamine formaldehyde, dialdehyde, boron compounds, zirconium compounds or mixtures thereof, but are not particularly limited thereto.

An example of the isocyanate is tolylene diisocyanate adduct (TDI adduct), and an example of the epoxide is epichlorohydrin. Examples of the dialdehyde include glyoxal and glutaric dialdehyde, but are not particularly limited thereto. Examples of the boron compounds include boric acid and Borax, and examples of the zirconium compounds include zirconyl acetate, zirconyl nitrate and zirconyl chloride, but are not particularly limited thereto.

In addition, a fixing agent, a dye, a fluorescent dye, an optical brightness improvement agent, a pH controller, an antioxidant agent, a defoamer, a deaerator, a leveling agent, a lubricant, an anti-curling agent, a surface controller, a wetting-improving agent, and the like, can be added as additives. The fluorescent dye is used to increase whiteness (apparent whiteness) which is visible to the naked eyes.

If the content of the additives is too low, the effects resulting from the addition of the additives are small, while if it is too high, the printing qualities and coating surface properties of the recording medium can deteriorate. In view of these properties, the total content of the additives in the composition for forming an ink acceptable layer is preferably about 0.015 to about 10 parts by weight, based on 100 parts by weight of the total solid content of the composition of the ink acceptable layer.

An exemplary embodiment of the present invention provides a recording medium for image forming apparatuses including a substrate having an ink acceptable layer from the composition for forming an ink acceptable layer comprising a fixing agent including polymeric materials containing UV-absorbing constituents, an inorganic filler, a binder, and a solvent.

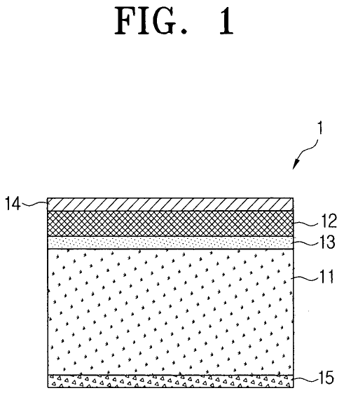

FIG. 1 is a cross-sectional view of a recording medium 1 for image forming apparatuses according to the exemplary embodiment of the present invention. The recording medium 1 comprises a substrate 11, an ink acceptable layer 12, an undercoating layer 13, a protective layer 14, and a back coating layer 15.

Generally, the recording medium 1 comprises the substrate 11 and ink acceptable layer 12. The undercoating layer 13 may be disposed between the substrate 11 and ink acceptable layer 12, and the protective layer 14 has ink permeability and is disposed on an upper surface of the ink acceptable layer 12. The back coating layer 15 may be disposed on a lower surface of the substrate 11, that is, on an opposite surface of ink acceptable layer 12 with respect to the substrate 11.

The substrate 11 is typically paper where the ink forms the image. The substrate may be selected from the group consisting of transparent or translucent polyester films, polycarbonate films, cellulose-acetate films, polyethylene films, paper with at least one side coated with polyethylene or polypropylene, single-sided art paper or double-sided art paper, cast coated paper, synthetic paper and photographic paper (or baryta paper).

The substrate 11 has a thickness of about 70 μm to about 350 μm so that it can be readily handled and also prevent bending when a coating layer is formed thereon.

As described above, the ink acceptable layer 12 contains the ink to be fixed. The ink acceptable layer 12 is preferably prepared using the composition for forming an ink acceptable layer according to the exemplary embodiment of the present invention. In other words, the composition for forming an ink acceptable layer comprises a fixing agent, an inorganic filler, a binder and a solvent, and the fixing agent is a polymeric material containing UV-absorbing constituents.

If the ink acceptable layer 12 is too thin, it cannot absorb ink, while if it is too thick, the cost of manufacture increases and drying during coating is difficult. Therefore, the ink acceptable layer preferably has a thickness of about 8 μm to about 80 μm.

The undercoating layer 13 is disposed between the substrate 11 and ink acceptable layer 12 to improve adhesion therebetween. The undercoating layer 13 comprises one material selected from the group consisting of bi-component primer of polyol and polyisocyanate or mono-component primer of acryl, urethane, acryl-urethane and vinyl based compounds, and the amount of the material is preferably about 0.2 g/m² to about 2 g/m².

The undercoating layer 13 preferably has a thickness of 0.2 μm to 2.0 μm, and more preferably 0.2 μm to 1.0 μm.

The protective layer 14, which is coated on the upper part of the ink acceptable layer 12 and is hardened to provide excellent surface strength while showing superior ink permeability, comprises either a compound comprising a cellulose and a cross-linker, or a compound comprising a polyethylene oxide and a cross-linker. The protective layer 14 preferably has a thickness of about 0.5 μm to about 3 μm.

The back coating layer 15 is used in order to complement consecutive paper feeding and the curling phenomenon. The back coating layer 15 is preferably selected from compounds comprising, polyvinyl alcohol, polyvinylpyrrolidone, methyl cellulose, hydroxypropylmethyl cellulose, gelatin, polyethylene oxide, acrylic polymers, polyesters and polyurethanes, which are used as binders contained in the ink absorption layer 12, and oxazoline, isocyanate, epoxide, aziridine, melamine-formaldehyde, dialdehyde and boron compounds, which are used as cross-linkers.

Additionally, the back coating layer 15 preferably has a thickness of about 0.5 μm to about 4 μm.

A method for preparing a recording medium for image forming apparatuses according to the exemplary embodiment of the present invention comprises preparing a composition for forming an ink acceptable layer, which comprises a fixing agent including polymeric materials containing UV-absorbing constituents, an inorganic filler, a binder, and a solvent; coating the composition for forming an ink acceptable layer on the substrate; and drying the substrate coated with the composition at a temperature of 50° C. to 130° C.

To prepare the recording medium, first the composition for forming an ink acceptable layer is prepared. The obtained composition for forming the ink acceptable layer is coated on one surface of the substrate, followed by drying the substrate to form an ink acceptable layer. The drying is performed at 50° C. to 130° C. If the cross-linker is added to the composition for forming an ink acceptable layer, a thermal cross-linking reaction by the cross-linker occurs during drying. Accordingly, if the drying temperature is less than 50□, the cross-linking reactivity is reduced. If the drying temperature exceeds 130□, yellowing may occur. Therefore, the drying temperature should be adjusted within the temperature range from about 50° C. to about 130° C.

### EXAMPLES

Hereinafter, compositions for forming an ink acceptable layer are prepared in Preparation Examples 1 to 5, and compositions for forming an ink acceptable layer including a fixing agent containing UV-absorbing constituents according to the exemplary embodiment of the present invention are prepared in Preparation Examples 1 to 3.

### Preparation Example 1

430 parts of distilled water, 80 parts of a 25% aqueous solution of dodecyl trimethyl ammonium chloride, and 30 parts of 2-[2′-hydroxy-5′-(methacryloyloxy)phenyl]benzotriazole were added to a shake flask. The temperature of the resulting mixture was raised to 80° C., 40 parts of a 5% aqueous solution of 2,2′-azobis(2-amidinopropane)dihydrochloride was added thereto, and then the resulting mixture was left to stand for 5 minutes. After 5 minutes, an aqueous solution comprising 16 parts of the 25% aqueous solution of dodecyl trimethyl ammonium chloride, 48 parts of the 5% aqueous solution of 2,2′-azobis(2-amidinopropane)dihydrochloride, and 186 parts of distilled water; and a monomer comprising 120 parts of dimethylaminopropylacrylamide methyl chloride, 200 parts of methyl methacrylate, 320 parts of butyl acrylate and 160 parts of styrene were added thereto over 90 minutes, separately. The resulting mixture was continuously stirred for 60 minutes without change.

The resulting mixture was then cooled to 30° C. or lower, and subsequently filtered through an 80 mesh steel sieve. After filtration, water was added, and the mixture was adjusted until the solid content was 40%.

### Preparation Example 2

590 parts of distilled water, 80 parts of a 25% aqueous solution of dodecyl trimethyl ammonium chloride, and 240 parts of 2-hydroxy-4-acryloyl-oxybenzophenone were added to a shake flask. The temperature of the resulting mixture was raised to 80□, 40 parts of a 5% aqueous solution of 2,2′-azobis(2-amidinopropane)dihydrochloride was added thereto, and then the resulting mixture was left to stand for 5 minutes. After 5 minutes, an aqueous solution comprising 16 parts of the 25% aqueous solution of dodecyl trimethyl ammonium chloride, 48 parts of the 5% aqueous solution of 2,2′-azobis(2-amidinopropane) dihydrochloride, and 186 parts of distilled water; and a monomer comprising 120 parts of dimethylaminopropylacrylamide methyl chloride, 200 parts of methyl methacrylate, 320 parts of butyl acrylate and 160 parts of styrene were added thereto over 90 minutes, separately. The resulting mixture was continuously stirred for 60 minutes without change.

The resulting mixture was then cooled to 30° C. or lower, and subsequently filtered through an 80 mesh steel sieve. After filtration, water was added, and the mixture was adjusted until the solid content was 40%.

### Preparation Example 3

590 parts of distilled water, 80 parts of a 25% aqueous solution of dodecyl trimethyl ammonium chloride, and 240 parts of a 10% aqueous solution of 3-[N,N-phenylmethylmethaneamideimido]phenylallyl ester were added to a shake flask. The temperature of the resulting mixture was raised to 80° C., 40 parts of a 5% aqueous solution of 2,2′-azobis(2-amidinopropane)dihydrochloride was added thereto, and then the resulting mixture was left to stand for 5 minutes. After 5 minutes, an aqueous solution comprising 16 parts of the 25% aqueous solution of dodecyl trimethyl ammonium chloride, 48 parts of the 5% aqueous solution of 2,2′-azobis(2-amidinopropane)dihydrochloride, and 186 parts of distilled water; and a monomer comprising 120 parts of dimethylaminopropylacrylamide methyl chloride, 200 parts of methyl methacrylate, 320 parts of butyl acrylate and 160 parts of styrene were added thereto over 90 minutes, separately. The resulting mixture was continuously stirred for 60 minutes without change.

The resulting mixture was then cooled to 30° C. or lower, and subsequently filtered through an 80 mesh steel sieve. After filtration, water was added, and the mixture was adjusted until the solid content was 40%.

### Preparation Example 4

470 parts of distilled water, 80 parts of a 25% aqueous solution of dodecyl trimethyl ammonium chloride, and 400 parts of a 10% aqueous solution of 2-[2′-hydroxy-3′-methyl-5′-acryloyloxyphenyl]benzotriazole were added to a shake flask. The temperature of the resulting mixture was raised to 80° C., 40 parts of a 5% aqueous solution of 2,2′-azobis(2-amidinopropane)dihydrochloride was added thereto, and then the resulting mixture was left to stand for 5 minutes. After 5 minutes, an aqueous solution comprising 11 parts of the 25% aqueous solution of dodecyl trimethyl ammonium chloride, 33 parts of the 5% aqueous solution of 2,2′-azobis(2-amidinopropane)dihydrochloride, and 116 parts of distilled water; and a monomer for a shell comprising 100 parts of dimethylaminopropylacrylamide methyl chloride, 140 parts of methyl methacrylate, 200 parts of butyl acrylate and 120 parts of styrene were added thereto over 70 minutes, separately. The resulting mixture was continuously stirred for 30 minutes without change.

Subsequently, an aqueous solution comprising 5 parts of the 25% aqueous solution of dodecyl trimethyl ammonium chloride, 15 parts of the 5% aqueous solution of 2,2′-azobis(2-amidinopropane)dihydrochloride, and 50 parts of distilled water; and a monomer for a core comprising 50 parts of methyl methacrylate, 150 parts of butyl acrylate, 32 parts of styrene and 8 parts of metacryloxypropyltrimethoxysilane were added thereto over 30 minutes, separately. The resulting mixture was continuously stirred for 60 minutes without change.

The resulting mixture was then cooled to 30° C. or lower, and subsequently filtered through an 80 mesh steel sieve. After filtration, water was added, and the mixture was adjusted until the solid content was 40%.

### Preparation Example 5

470 parts of distilled water and 80 parts of a 25% aqueous solution of dodecyl trimethyl ammonium chloride were added to a shake flask. The temperature of the resulting mixture was raised to 80° C., 40 parts of a 5% aqueous solution of 2,2′-azobis(2-amidinopropane)dihydrochloride was added thereto, and then the resulting mixture was left to stand for 5 minutes. After 5 minutes, an aqueous solution comprising 11 parts of the 25% aqueous solution of dodecyl trimethyl ammonium chloride, 33 parts of the 5% aqueous solution of 2,2′-azobis(2-amidinopropane)dihydrochloride, and 116 parts of distilled water; and a monomer for a shell comprising 100 parts of dimethylaminopropylacrylamide methyl chloride, 140 parts of methyl methacrylate, 200 parts of butyl acrylate and 120 parts of styrene were added thereto over 70 minutes, separately. The resulting mixture was continuously stirred for 30 minutes without change.

Subsequently, an aqueous solution comprising 5 parts of the 25% aqueous solution of dodecyl trimethyl ammonium chloride, 15 parts of the 5% aqueous solution of 2,2′-azobis(2-amidinopropane)dihydrochloride, and 50 parts of distilled water; and a monomer for a core comprising 50 parts of methyl methacrylate, 150 parts of butyl acrylate, 32 parts of styrene and 8 parts of methacryloxypropyltrimethoxysilane were added thereto over 30 minutes, separately. The resulting mixture was continuously stirred for 60 minutes without change.

The resulting mixture was then cooled to 30° C. or lower, and subsequently filtered through an 80 mesh steel sieve. After filtration, water was added, and the mixture was adjusted until the solid content was 40%.

### Example 1

A composition for forming an ink acceptable layer comprising the following composition was prepared to manufacture a recording medium for inkjet image forming apparatuses.

| | Content |
|---|---|
| Composition | (parts by weight) |
| Alumina (HP14, produced by Sasol, Germany) | 87.5 |
| Polyvinyl alcohol (PVA 224E, produced by | 7.0 |
| Kuraray, Japan) | |
| Fixing agent containing UV-absorbing constituents | 3.9 |
| prepared in Preparation Example 1 | |
| Leveling agent (Flow 425, produced by Tego, | 1.0 |
| Germany) | |
| Fluorescent dye (SW5274F, produced by Samwon Co., | 0.5 |
| Ltd., Korea) | |
| Boric acid (produced by SAMCHUN PURE | 0.1 |
| CHEMICAL. Co., Ltd., Korea) | |
| Solvent-distilled water:ethanol:dimethylformamide | 400 |
| (weight ratio, 75:10:15) | |

The composition for forming an ink acceptable layer described in Example 1 was applied to gelatin-treated photographic paper (e.g. baryta paper) with a basis weight of 200 g/m² using a bar coater, and dried at a temperature of 110° C. for 3 minutes.

A recording medium for inkjet image forming apparatuses having an ink acceptable layer with a thickness of about 35 μm was prepared.

### Example 2

A recording medium for inkjet image forming apparatuses was prepared in the same manner as in Example 1, except that the following composition was used for forming an ink acceptable layer.

| | Content |
|---|---|
| Composition | (parts by weight) |
| Alumina sol (PG 003, produced by Cabot, USA) | 85.0 |
| Polyvinyl alcohol (PVA 224E, produced | 10.0 |
| by Kuraray, Japan) | |
| Fixing agent containing UV-absorbing constituents, | 2.8 |
| prepared in Preparation Example 2 | |
| Glyoxal (produced by SAMCHUN PURE | 0.65 |
| CHEMICAL. Co., Ltd., Korea) | |
| Leveling agent (Flow 425, produced by Tego, | 1.0 |
| Germany) | |
| Fluorescent dye (SW5274F, produced by Samwon Co., | 0.5 |
| Ltd., Korea) | |
| Boric acid (produced by SAMCHUN PURE | 0.05 |
| CHEMICAL. Co., Ltd., Korea) | |
| Solvent-distilled water:ethanol:dimethylformamide | 400 |
| (weight ratio, 70:10:20) | |

A recording medium for inkjet image forming apparatuses having an ink acceptable layer with a thickness of about 35 μm was prepared.

### Example 3

A recording medium for inkjet image forming apparatuses was prepared in the same manner as in Example 1, except that the following composition was used for forming an ink acceptable layer.

| | Content |
|---|---|
| Composition | (parts by weight) |
| Alumina sol (SS-30, produced by HANA Chemical | 76.9 |
| Co., Korea) | |
| Alumina (ALUMINIUMOXID C, produced by | 8.5 |
| Degussa, Germany) | |
| Polyvinyl alcohol (PVA P-17, produced by Dongyang | 8.0 |
| Chem. Co., Ltd., Korea) | |
| Fixing agent containing UV-absorbing constituents, | 4.0 |
| prepared in Preparation Example 3 | |
| Zirconium oxychloride (produced by Junsei Chemical | 1.0 |
| Co., Japan) | |
| Leveling agent (Flow 425, produced by Tego, | 1.0 |
| Germany) | |
| Fluorescent dye (SW5274F, produced by Samwon Co., | 0.5 |
| Ltd., Korea) | |
| Boric acid (produced by SAMCHUN PURE | 0.1 |
| CHEMICAL. Co., Ltd., Korea) | |
| Solvent-distilled | 400 |
| water:ethanol:dimethylformamide:dimethylsulfoxide | |
| (weight ratio, 70:10:15.5:5) | |

A recording medium for inkjet image forming apparatuses having an ink acceptable layer with a thickness of about 35 μm was prepared.

### Comparative Example 1

A recording medium for inkjet image forming apparatuses was prepared in the same manner as in Example 1, except that the following composition was used for forming an ink acceptable layer.

| | Content |
|---|---|
| Composition | (parts by weight) |
| Alumina (ALUMINIUMOXID C, produced by | 91.1 |
| Degussa, Germany) | |
| Polyvinyl alcohol (PVA 224E, produced by Kuraray, | 7.3 |
| Japan) | |
| Leveling agent (Flow 425, produced by Tego, | 1.0 |
| Germany) | |
| Fluorescent dye (SW5274F, produced by Samwon | 0.5 |
| Co., Ltd., Korea) | |
| Boric acid (produced by SAMCHUN PURE | 0.1 |
| CHEMICAL. Co., Ltd., Korea) | |
| Solvent-distilled water:ethanol:dimethylformamide | 400 |
| (weight ratio, 75:10:15) | |

A recording medium for inkjet image forming apparatuses having an ink acceptable layer with a thickness of about 35 μm was prepared.

### Comparative Example 2

A recording medium for inkjet image forming apparatuses was prepared in the same manner as in Example 1, except that the following composition was used for forming an ink acceptable layer.

| | Content |
|---|---|
| Composition | (parts by weight) |
| Alumina sol (PG 003, produced by Cabot, USA) | 86.3 |
| Polyvinyl alcohol (PVA 117, produced by Kuraray, | 10.2 |
| Japan) | |
| Fixing agent prepared in Preparation Example 4 | 1.3 |
| Glyoxal (produced by SAMCHUN PURE | 0.65 |
| CHEMICAL. Co., Ltd., Korea) | |
| Leveling agent (Flow 425, produced by Tego, | 1.0 |
| Germany) | |
| Fluorescent dye (SW5274F, produced by Samwon Co., | 0.5 |
| Ltd., Korea) | |
| Boric acid (produced by SAMCHUN PURE | 0.05 |
| CHEMICAL. Co., Ltd., Korea) | |
| Solvent-distilled water:ethanol:dimethylformamide | 400 |
| (weight ratio, 70:10:20) | |

A recording medium for inkjet image forming apparatuses having an ink acceptable layer with a thickness of about 35 μm was prepared.

### Comparative Example 3

A recording medium for inkjet image forming apparatuses was prepared in the same manner as in Example 1, except that the following composition was used for forming an ink acceptable layer.

| | Content |
|---|---|
| Composition | (parts by weight) |
| Alumina sol (SS-30, produced by HANA Chemical | 78.7 |
| Co., Korea) | |
| Alumina (ALUMINIUMOXID C, produced by | 8.7 |
| Degussa, Germany) | |
| Polyvinyl alcohol (PVA 224E, produced by Kuraray, | 8.0 |
| Japan) | |
| UV absorber: 2-[2′-hydroxy-3′-methyl- | 1.0 |
| 5′-methylphenyl]benzotriazole | |
| (produced by Evergreen Moolsan Corp.) | |
| Zirconium oxychloride (produced by Junsei Chemical | 1.0 |
| Co., Japan) | |
| Leveling agent (Flow 425, produced by Tego, | 1.0 |
| Germany) | |
| Fluorescent dye (SW5274F, produced by Samwon | 0.5 |
| Co., Ltd., Korea) | |
| Boric acid (produced by SAMCHUN PURE | 0.1 |
| CHEMICAL. Co., Ltd., Korea) | |
| Solvent-distilled | 400 |
| water:ethanol:dimethylformamide:dimethylsulfoxide | |
| (weight ratio, 70:10:15.5:5) | |

A recording medium for inkjet image forming apparatuses having an ink acceptable layer with a thickness of about 35 μm was prepared.

### Comparative Example 4

A recording medium for inkjet image forming apparatuses was prepared in the same manner as in Example 1, except that the following composition was used for forming an ink acceptable layer.

| | Content |
|---|---|
| Composition | (parts by weight) |
| Alumina sol (PG 003, produced by Cabot, USA) | 85.0 |
| Polyvinyl alcohol (PVA 224E, produced by Kuraray, | 10.0 |
| Japan) | |
| Fixing agent prepared in Preparation Example 5 | 1.8 |
| UV absorber: 2-[2′-hydroxy-3′-methyl- | 1.0 |
| 5′-methylphenyl]benzotriazole | |
| (produced by Evergreen Moolsan Corp.) | |
| Glyoxal (produced by SAMCHUN PURE | 0.65 |
| CHEMICAL. Co., Ltd., Korea) | |
| Leveling agent (Flow 425, produced by Tego, | 1.0 |
| Germany) | |
| Fluorescent dye (SW5274F, produced by Samwon | 0.5 |
| Co., Ltd., Korea) | |
| Boric acid (produced by SAMCHUN PURE | 0.05 |
| CHEMICAL. Co., Ltd., Korea) | |
| Solvent-distilled water:ethanol:dimethylformamide | 400 |
| (weight ratio, 70:10:20) | |

On the inkjet recording media prepared in Examples 1 to 3 and Comparative Examples 1 to 4, an image was printed using a color ink-jet printer Model MJC-1130i, produced by Samsung Electronics Co., Ltd., Korea.

The inkjet recording media according to Examples 1 to 3 and Comparative Examples 1 to 4, on which the image was printed as described above, were evaluated for their ink absorption, color image sharpness (i.e. bleeding), moisture resistance, light resistance, discoloration resistance or the like. Examples of such evaluation methods include the following.

### Evaluation Method

(1) Test of Ink Absorption

After a standard image (e.g. MJC-1130i) formed mainly of black mixed ink was printed on an A4 size specimen, a woodfree paper was overlapped and pressed for 10 seconds using a 5 kg iron mass. The amount of ink smearing on the woodfree paper was observed.

As a result, when ink was not smeared on the paper, it was graded “Excellent”, when a small amount (5% or less) of the ink was smeared, it was graded “Good”, when an amount of about 5 to about 50% of the ink was smeared, it was graded “Poor”, and when over 50% of the ink was smeared, it was graded “Very Poor.”

(2) Test of Bleeding

A standard line (e.g. MJC-1130i) formed mainly of composite black mixed ink was printed on an A4 size specimen, and 24 hours later, the sharpness of the standard line was observed.

As a result, when the standard line was found to have bled by 1% or less of the thickness of the standard line, it was graded “Excellent”, when the line was found to have bled by 1 to 5%, it was graded “Good”, when the line was found to have bled by 5 to 10%, it was graded “Poor”, and when the line was found to have bled by over 10%, it was graded “Very Poor.”

(3) Test of Water Resistance

After a standard image (e.g. MJC-1130i) formed mainly of color ink was printed on an A4 size specimen, the specimen was left to stand in a thermo-hygrostat (60□ and 95%) for 24 hours, and the specimen was observed to detect whether the image had bled.

As a result, when the standard image was found to have bled by 5% or less of the thickness of the standard line, it was graded “Excellent”, when the image was found to have bled by 5 to 10%, it was graded “Good”, when the image was found to have bled by 10 to 20%, it was graded “Poor”, and when the image was found to have bled by over 20%, it was graded “Very Poor.”

The inkjet recording media according to Examples 1 to 3, and Comparative Examples 1 to 3, on which the image was printed as described above, were evaluated for their ink absorption, color image sharpness (i.e. bleeding), short-term and long-term water resistance and moisture resistance. The results of the evaluation are shown in Table 1.

(4) Test of Light Resistance

Using a light resistance tester (Q-SUN 3000; Xenon lamp), light of 1.1 W/m² was irradiated for 10 hours under conditions wherein irradiation energy was 420 nm and the black panel temperature was 63° C. Yellow, magenta, cyan and black beta images were printed using the same image forming apparatus as described above, and then L*, a* and b* were measured. ΔE was obtained from a difference between the values before and after the test, and the light resistance was evaluated according to the following evaluation standards.

### <Evaluation Standards >

\textcircled{0}: ΔE is less than 3.
◯: ΔE is 3 to 7.
Δ: ΔE is 7 to 10.
×: ΔE is 10 or more.

(5) Test of Discoloration Resistance

Using a gas corrosion tester, ink was left to stand for 2 hours under an atmosphere of a mixed gas (O₃, SO₂, and NO₂). Yellow, magenta, cyan and black beta images were printed using the same image forming apparatus as described above, and then L*, a* and b* were measured. ΔE was obtained from a difference between the values before and after the test, and the light resistance was evaluated according to the following evaluation standards.

### <Evaluation Standards >

\textcircled{0}: ΔE is less than 3.
◯: ΔE is 3 to 7.
Δ: ΔE is 7 to 10.
×: ΔE is 10 or more.

(6) Test of Glossiness

Glossiness was evaluated at 85° C. using a glossiness tester (micro-TRI-gloss glossmeter manufactured by BYK Gardner, Germany). Higher glossiness values correspond to superior levels of glossiness.

TABLE 1

| | Ink | Sharpness | Water | Light | Discoloration | |
|---|---|---|---|---|---|---|
| Item | Absorption | (Bleeding) | Resistance | Resistance | Resistance | Glossiness |
| Example 1 | ⊚ | ⊚ | ⊚ | ⊚ | ⊚ | 95.0 |
| Example 2 | ⊚ | ⊚ | ⊚ | ⊚ | ⊚ | 92.3 |
| Example 3 | ⊚ | ⊚ | ◯ | ⊚ | ⊚ | 92.5 |
| Comparative | ⊚ | ◯ | Δ | X | X | 89.0 |
| Example 1 | | | | | | |
| Comparative | ⊚ | ⊚ | ⊚ | X | Δ | 93.6 |
| Example 2 | | | | | | |
| Comparative | ⊚ | ◯ | Δ | ⊚ | ◯ | 78.9 |
| Example 3 | | | | | | |
| Comparative | ⊚ | ◯ | ◯ | ◯ | Δ | 60.3 |
| Example 4 | | | | | | |

In Table 1, ⊚ represents “Excellent”, ◯ represents “Good”, Δ represents “Poor”, and X represents “Very poor.”

Referring to Table 1, it was found that the recording media for image forming apparatuses prepared in Examples 1 to 3, had excellent or good light resistance and discoloration resistance while maintaining improved ink fixation properties when the recording media were prepared by adding a cationic latex containing UV-absorbing constituents as a fixing agent to an ink acceptable layer and using the cationic latex.

It was found that among ink fixation properties, the recording medium prepared using the composition for forming an ink acceptable layer according to Comparative Example 1, which did not include a UV absorber, a cationic latex or a cationic latex containing UV-absorbing constituents, had excellent sharpness but poor moisture resistance, and also had very poor light resistance and discoloration resistance.

It was found that the recording medium prepared in Comparative Example 2, which included as a fixing agent only a cationic latex not containing UV-absorbing constituents, showed excellent sharpness and moisture resistance with the cationic latex acting as a fixing agent, but poor or very poor light resistance and discoloration resistance because of the lack of UV-absorbing constituents was either internally or even externally.

It was found that the recording medium prepared in Comparative Example 3, which included a UV absorber but did not include a cationic latex as a fixing agent, showed good light resistance and discoloration resistance due to the performance of the UV absorber but slightly lower sharpness and moisture resistance because the cationic latex acting as a fixing agent was not included.

It was found that the recording medium prepared in Comparative Example 4, which included an additive UV absorber and a cationic latex as a fixing agent, had excellent sharpness, moisture resistance and light resistance but poor discoloration resistance. Additionally, since compatibility of the UV absorber with the cationic latex as a fixing agent was low, the glossiness was considerably inferior.

As described above, the embodiments of the present invention provide an ink acceptable layer formed in a recording medium for image forming apparatuses. The ink acceptable layer has superior light resistance and discoloration resistance while maintaining improved ink fixation properties and glossiness, by comprising a cationic latex internally containing UV-absorbing constituents as a fixing agent required for inks to be fixed. Therefore, it is possible to provide a recording medium having excellent performances.

As aforementioned, the exemplary embodiments of the present invention are shown and described, but the present invention is not limited to the specific embodiments described above, and can be implemented in various modifications by those skilled in the art to which the present invention pertains without departing from the scope of the invention as defined by the appended claims and the full scope of equivalents thereof.

What is claimed is:

1. A composition to form an ink acceptable layer of a recording medium for an image forming apparatus, the composition comprising:
a fixing agent;
an inorganic filler;
a binder; and
a solvent,
wherein the fixing agent is a polymeric material containing ultraviolet light (UV)-absorbing constituents.

2. The composition as claimed in claim 1, wherein the fixing agent is an acrylate based cationic latex.

3. The composition as claimed in claim 1, wherein the fixing agent is represented by the following Formula (I),
-[A]ₗ-[B]ₘ—[C]ₙ— (I)
in which A is a radical polymerizable monomer containing at least one of a tertiary amino group and a quaternary ammonium group;
B is a radical polymerizable monomer copolymerizable with A;
C is a UV-absorbing monomer and is selected from the group consisting of a benzophenone-based UV-absorbing monomer, a benzotriazole-based UV-absorbing monomer and a formamidine-based UV-absorbing monomer;
l is a natural number from 5 to 40;
m is a natural number from 40 to 75;
n is a natural number from 20 to 55; and
l+m+n=100.

4. The composition as claimed in claim 3, wherein A is selected from the group consisting of di-C₁-C₄ alkylamino-C₂-C₃ alkyl acrylamides and salts thereof, di-C₁-C₄ alkylamino-C₂-C₃ alkyl methacrylamides and salts thereof, di-C₁-C₄ alkylamino-C₂-C₃ alkyl acrylates and salts thereof, di-C₁-C₄ alkylamino-C₂-C₃ alkyl methacrylates and salts thereof, di-C₁-C₄ alkylamino-C₂-C₃ alkyl-substituted aromatic vinyl compounds and salts thereof, and nitrogen containing heterocyclic radical polymerizable monomers and salts thereof.

5. The composition as claimed in claim 3, wherein B is selected from the group consisting of an unsaturated aromatic compound, an α,β-unsaturated monocarboxylic acid alkyl ester, an amide group-containing compound, an unsaturated carboxylic acid, and a hydroxyl group-containing compound.

6. The composition as claimed in claim 5, wherein the unsaturated aromatic compound is selected from the group consisting of styrene, a-methyl styrene, and vinyl toluene.

7. The composition as claimed in claim 5, wherein the alky ester of the α,β-unsaturated monocarboxylic acid is an alkyl ester of acrylic acid or an alkyl ester of methacrylic acid.

8. The composition as claimed in claim 7, wherein the alkyl ester of acrylic acid is selected from the group consisting of methyl acrylate, ethyl acrylate, propyl acrylate, isopropyl acrylate, butyl acrylate, isobutyl acrylate, hexyl acrylate, cyclohexyl acrylate, 2-ethylhexyl acrylate, and lauryl acrylate.

9. The composition as claimed in claim 7, wherein the alkyl ester of methacrylic acid is selected from the group consisting of methyl methacrylate, ethyl methacrylate, propyl methacrylate, isopropyl methacrylate, butyl methacrylate, isobutyl methacrylate, hexyl methacrylate, cyclohexyl methacrylate, 2-ethylhexyl methacrylate, and lauryl methacrylate.

10. The composition as claimed in claim 5, wherein the amide group-containing compound is selected from the group consisting of acrylamide, methacrylamide, N,N-methylene bisacrylamide, diacetone acrylamide, maleic acid amide, and maleimide.

11. The composition as claimed in claim 5, wherein the unsaturated carboxylic acid is selected from the group consisting of acrylic acid, methacrylic acid, maleic acid, fumaric acid, itaconic acid, and monoalkyl itaconate.

12. The composition as claimed in claim 5, wherein the hydroxyl group-containing compound is selected from the group consisting of 2-hydroxyethyl acrylate, 2-hydroxyethyl methacrylate, hydroxypropyl acrylate, hydroxypropyl methacrylate, and polyethylene glycol acrylate.

13. The composition as claimed in claim 3, wherein the benzophenone-based UV-absorbing monomer is represented by the following Formula (II), 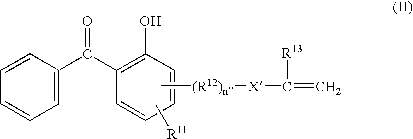
in which R¹¹ is selected from the group consisting of a hydrogen atom, a C₁-C₆ alkyl group, and a C₁-C₆ alkoxyl group;
R¹² is selected from the group consisting of a C₁-C₁₀ alkylene group, and a C₁-C₁₀ oxyalkylene group;
R¹³ is selected from the group consisting of a hydrogen atom, and a C₁-C₄ alkyl group;
X¹ is one of an ester bond, an amide bond, an ether bond, and a urethane bond; and
n¹¹ is 0 or 1.

14. The composition as claimed in claim 3, wherein the benzotriazole-based UV-absorbing monomer is represented by the following Formula (III), 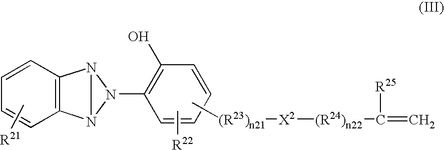
in which R²¹ is selected from the group consisting of a hydrogen atom, a halogen atom, and a methyl group;
R²² is selected from the group consisting of a hydrogen atom, and a C₁-C₆ hydrocarbon group;
R²³ is selected from the group consisting of a C₁-C₁₀ alkylene group, and a C₁-C₁₀ oxyalkylene group;
R²⁴ is selected from the group consisting of a C₁-C₈ alkylene group, a C₁-C₈ alkylene group with an amino group, and a C₁-C₈ alkylene group with a hydroxyl group;
R²⁵ is selected from the group consisting of a hydrogen atom, and a C₁-C₄ alkyl group;
X² is an ester bond, an amide bond, an ether bond, and a urethane bond; and
n²¹ and n²² are 0 or 1.

15. The composition as claimed in claim 3, wherein the formamidine-based UV-absorbing monomer is represented by the following Formula (IV), 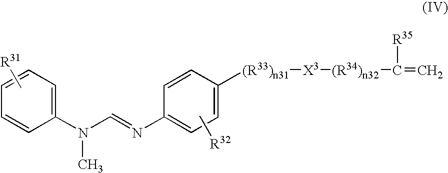
in which R³¹ is selected from the group consisting of a hydrogen atom, a halogen atom, and a methyl group;
R³² is selected from the group consisting of a hydrogen atom, and a C₁-C₆ hydrocarbon group;
R³³ is selected from the group consisting of a C₁-C₁₀ alkylene group, and a C₁-C₁₀ oxyalkylene group;
R³⁴ is selected from the group consisting of a C₁-C₈ alkylene group, a C₁-C₈ alkylene group with an amino group, and a C₁-C₈ alkylene group with a hydroxyl group;
R³⁵ is selected from the group consisting of a hydrogen atom, and a C₁-C₄ alkyl group;
X² is an ester bond, an amide bond, an ether bond, and a urethane bond; and
n³¹ and n are 0 or 1.

16. The composition as claimed in claim 3, wherein the fixing agent has a particle size of about 10 nm to about 500 nm.

17. The composition as claimed in claim 3, wherein the fixing agent is included in an amount of about 0.5 to about 25 parts by weight, based on 100 parts by weight of the total solid content of the composition of the ink acceptable layer.

18. The composition as claimed in claim 1, wherein the inorganic filler is selected from the group consisting of alumina, calcium carbonate, kaolin, talc, calcium sulfate, barium sulfate, titanium oxide, zinc oxide, zinc carbonate, aluminum silicate, silicic acid, sodium silicate, magnesium silicate, calcium silicate and silica.

19. The composition as claimed in claim 1, wherein the inorganic filler is the alumina, and the alumina is represented by the following Formula (V),
Al₂O₃₋ₚ(OH)₂ₚ·_{q}H₂O (V)
in which p is an integer from 0 to 3; and q is a rational number from 0 to 10.

20. The composition as claimed in claim 19, wherein the alumina has either a boehmite structure or an amorphous structure.

21. The composition as claimed in claim 19, wherein the alumina has a particle size of about 20 nm to about 200 nm.

22. The composition as claimed in claim 19, wherein the alumina is included in an amount of about 50 to about 95 parts by weight, based on 100 parts by weight of the total solid content of the composition of the ink acceptable layer.

23. The composition as claimed in claim 1, wherein the binder comprises a polyvinyl alcohol.

24. The composition as claimed in claim 23, wherein the polyvinyl alcohol has a polymerization degree of 1000 or more, and a degree of saponification of 70 to 100 parts.

25. The composition as claimed in claim 23, wherein the binder further comprises one or more compounds selected from the group consisting of polyvinylpyrrolidone, methyl cellulose, hydroxypropylmethyl cellulose, gelatin, starch, polyethylene oxide, acrylic polymers, polyesters and polyurethanes, and
the compound is further contained in an amount of about 1 to about 50 parts by weight, based on 100 parts by weight of the total weight of the polyvinyl alcohol.

26. The composition as claimed in claim 1, wherein the content of the binder is 5 to 30 parts by weight, based on 100 parts by weight of the total solid content of the composition of the ink acceptable layer.

27. The composition as claimed in claim 1, wherein the solvent comprises water and one or more organic solvents selected from the group consisting of ketones, glycol ethers, alcoholic solvents, methyl cellosolve, ethyl cellosolve, dimethylformamide and dimethylsulfoxide.

28. The composition as claimed in claim 27, wherein the water content is about 5 to about 40 parts by weight, based on 100 parts by weight of the total solid content of the composition of the ink acceptable layer, and the content of the organic solvents is about 5 to about 50 parts by weight, based on 100 parts by weight of the total weight of the solvent.

29. The composition as claimed in claim 1, further comprising a cross-linker.

30. The composition as claimed in claim 29, wherein the cross-linker is selected from the group consisting of oxazoline, isocyanate, epoxide, aziridine, melamine formaldehyde, dialdehyde, boron compounds, zirconium compounds and mixtures thereof.

31. A recording medium for image forming apparatuses comprising a substrate in which an ink acceptable layer is formed from a composition for forming an ink acceptable layer comprising a fixing agent including polymeric materials containing UV-absorbing constituents, an inorganic filler, a binder, and a solvent.

32. The recording medium as claimed in claim 31, wherein the ink acceptable layer has a thickness of about 8 μm to about 80 μm.

33. The recording medium as claimed in claim 31, wherein the substrate is selected from the group consisting of transparent or translucent polyester films, polycarbonate films, cellulose-acetate films, polyethylene films, paper with at least one side coated with polyethylene or polypropylene, single-sided art paper or double-sided art paper, cast coated paper, synthetic paper and photographic paper.

34. The recording medium as claimed in claim 31, wherein the substrate has a thickness of about 70 μm to about 350 μm.

35. The recording medium as claimed in claim 31, further comprising one or more layers selected from an undercoating layer disposed between the substrate and the ink acceptable layer, a protective layer disposed on an upper surface of the ink acceptable layer, and a back coating layer disposed on a lower surface of the substrate.

36. The recording medium as claimed in claim 35, wherein the undercoating layer comprises one material selected from the group consisting of bi-component primer of polyol and polyisocyanate or mono-component primer of acryl, urethane, acryl-urethane and vinyl based compounds.

37. The recording medium as claimed in claim 35, wherein the protective layer comprises either a compound comprising a cellulose and a cross-linker, or a compound comprising a polyethylene oxide and a cross-linker.

38. The recording medium as claimed in claim 35, wherein the back coating layer comprises one compound selected from polyvinyl alcohol, polyvinylpyrrolidone, methyl cellulose, hydroxypropylmethyl cellulose, gelatin, polyethylene oxide, acrylic polymer, polyester, polyurethane, oxazoline, isocyanate, epoxide, aziridine, melamine-formaldehyde, dialdehyde and boron compounds.

39. The recording medium as claimed in claim 35, wherein the undercoating layer has a thickness of about 0.2 μm to about 2.0 μm, the protective layer has a thickness of about 0.5 μm to about 3 μm, and the back coating layer has a thickness of about 0.5 μm to about 4 μm.

40. A method for preparing a recording medium for image forming apparatuses, comprising:
preparing a composition for forming an ink acceptable layer, which comprises a fixing agent including polymeric materials containing UV-absorbing constituents, an inorganic filler, a binder, and a solvent;
coating the composition for forming an ink acceptable layer on a substrate; and
drying the substrate coated with the composition at a temperature from 50° C. to 130° C.
